(19) United States
(12) Patent Application Publication
(10) Pub. No.: US 2019/0355245 A1
(43) Pub. Date: Nov. 21, 2019

(54) METHOD FOR ASCERTAINING DATA OF A TRAFFIC SCENARIO

(71) Applicant: Robert Bosch GmbH, Stuttgart (DE)

(72) Inventors: Fabian Gigengack, Hannover (DE); Holger Janssen, Hessisch Oldendorf (DE)

(21) Appl. No.: 16/476,987

(22) PCT Filed: Mar. 27, 2018
(86) PCT No.: PCT/EP2018/057743

§ 371 Date: Jul. 10, 2019

(30) Foreign Application Priority Data
Apr. 12, 2017 (DE) 10 2017 206 343.2

(51) Int. Cl. G08G 1/01

(52) U.S. Cl. CPC G08G 1/0129

(57) ABSTRACT

A method for ascertaining data of a traffic scenario having the steps: —detecting an environment of a vehicle with the aid of a sensor device; —detecting behaviors of road users with the aid of the sensor device; —combining and evaluating the detected data of the environment and the behaviors of the road users; and—storing the combined and evaluated data.

### FIELD

The present invention relates to a method for ascertaining data of a traffic scenario. In addition, the present invention relates to a device for ascertaining data of a traffic scenario. The present invention also relates to a computer program product.

### BACKGROUND INFORMATION

Vehicles driving in an automated or automatic driving manner require sensors and methods for detecting the environment. This detection of the environment is accomplished by suitable methods in such a way that the driving task is able to be carried out.

Existing methods for a scene interpretation directly utilize the sensors installed in the vehicle at the respective current instants.

Two conventional approaches for interpreting a scene are:
Elements that simplify the interpretation of street scenarios are included in digital maps to an increasing extent. Examples include speed limits, which are normally communicated to the driver through traffic signs as part of the traffic infrastructure. These signs are a component of modern digital maps. Another example is detailed information about the number and type of traffic lanes in digital maps, which is meant to make it easier to allocate an explicit traffic lane to the driver, e.g., when executing a turning maneuver.
Conventionally, information from the traffic infrastructure (such as lane markings, traffic lights, traffic signs, stop lines, further markings on the road such as street light posts, etc.) is detected online via cameras, and aggregated via crowd sourcing methods in order to form what is known as a road book. This road book is made available to involved vehicles.

### SUMMARY

An object of the present invention is to provide an improved detection of a traffic scenario.

According to a first aspect of the present invention, the object may be achieved by an example method for ascertaining data of a traffic scenario, the example method having the steps:
Detecting an environment of a vehicle with the aid of a sensor device;
Detecting behaviors of road users with the aid of the sensor device;
Combining and evaluating the detected data of the environment and the behaviors of the road users; and
Storing the combined and evaluated data.

This means that vehicles are able to profit from the wealth of experience of road users. In an advantageous manner, it is thereby possible to increase the safety while a vehicle is driven. A type of best practice aggregation is ultimately provided in this way, which takes into account behaviors of road users that are correct (“best practice”) and therefore enhances the safe driving operation of vehicles. This advantageously makes it possible to reduce the sensor expense for the vehicle.

According to a second aspect, the objective is achieved by a device for detecting a traffic scenario, the device including:
a sensor device for detecting an environment of the vehicle, the sensor device being used to detect behaviors of at least one road user;
a processing device for combining and evaluating the detected data of the environment and the behaviors of the at least one road user; and
a memory for storing the combined and evaluated data.

Advantageous further developments of the present method are described herein.

According to one advantageous further development of the present method, the combining and evaluating of the detected data of the environment and the behaviors of the road users is carried out inside or outside the vehicle. This provides different options for combining and evaluating the detected data.

One additional advantageous further development of the present method is characterized in that the combined and evaluated data are stored in an internal or an external digital map of the vehicle. This makes it easier to use both external and internal digital maps for the present method.

According to another advantageous further development of the present method, the combining and evaluating of the acquired data includes an averaging operation. A specific type of evaluation of the acquired data is thereby carried out.

According to another advantageous further development of the present method, the combining and evaluating of the acquired data includes an application of exclusion criteria. This provides another specific way of evaluating the acquired data.

According to another advantageous further development of the present method, at least one of the following is considered when combining and evaluating the acquired data: a local aspect, a temporal aspect, aspects pertaining to behavior patterns, and the use of external information. In this way, different aspects are taken into account when combining and evaluating acquired data.

According to another advantageous further development of the present method, the external information includes at least one of the following information: data pertaining to the weather, accident statistics, and police data. This advantageously utilizes different external information for the present method.

According to another advantageous further development of the present method, the combined and evaluated data are used for an information system and/or for a driver-assistance system of the vehicle. Advantageous application cases of the present method are thereby made available. For example, the combined and evaluated data may support a high availability of a longitudinal and/or transverse control of the vehicle.

Below, the present invention is described in detail together with further features and advantages on the basis of a plurality of figures. The figures are primarily intended to illustrate main features of the present invention and are not necessarily drawn true to scale.

Disclosed method features similarly result from correspondingly disclosed device features, and vice versa. This particularly means that features, technical advantages and embodiments pertaining to the present method result in a similar manner from corresponding embodiments, features and advantages relating to the present device, and vice versa.

### BRIEF DESCRIPTION OF THE DRAWINGS

FIG. 1 shows a basic representation of a method of functioning of the method according to the present invention.

FIG. 2 shows exemplary traffic scenarios that may be used for the present method.

FIG. 3 shows a schematic sequence of an embodiment of the method according to the present invention.

### DETAILED DESCRIPTION OF EXAMPLE EMBODIMENTS

Below, the term “automated vehicle” is synonymously used in the sense of a fully automated vehicle, a partly automated vehicle, a fully autonomous vehicle, and a partly autonomous vehicle.

One aspect of the present invention may particularly be understood as the creation of a database which considers a behavior of other road users and thereby contributes to a better quality of a digital map. Scene elements are utilized in the process and behavior patterns at the current and/or other point(s) in time are used by the ego vehicle and/or other vehicles. In accordance with the present invention, it is proposed to provide for the storage and aggregation of behavior patterns of vehicles and/or the interpretation of their behavior in the interaction with the infrastructure. These aspects are described in greater detail herein.

Due to the high complexity of a complete scene interpretation, conventional methods provide only a limited understanding of the scene, and thus only limited driving functions. Therefore, a comprehensive scene interpretation of automotive traffic situations, which will be necessary in the future, especially for autonomous driving, is provided.

The provided method uses a reciprocal context between the traffic infrastructure and the behavior of road users (all vehicles, pedestrians). On the one hand, the traffic infrastructure (e.g., the extension of a road) induces a specific behavior of the road users. On the other hand, when observing the behavior of road users, a specific development of the infrastructure is able to be inferred with the aid of the context (e.g., “the cars are driving on the road”). The detection range or the forecast of the extension of the current road is able to be greatly expanded when monitoring vehicles on the road.

The current behavior of a road user may be denoted as “best practice”, which describes a behavior of the road user that proves to be “correct” or “unproblematic” in the respective situation and contributes to a smooth traffic situation.

For example, one strategy for driving during the current situation may be to follow a vehicle that is driving ahead. As long as this vehicle obeys the applicable traffic laws, does not cause an accident, or in other words, implements a best practice, there is no reason (e.g., a traffic light turned red) not to trail said vehicle. As long as the vehicle driving ahead travels along the ego route, this may constitute a successful driving strategy.

If one observes the best practices of different road users in the current situation, then this may improve the interpretation of the current situation quite considerably. If the system according to the present invention remembers the best practices in a certain driving situation for a longer period of time, an expanded picture emerges of what is possible and advantageous in this particular situation in terms of behaviors and measures.

If this aspect of the present invention is expanded to apply to multiple locations and different points in time along a route a vehicle is traveling, then this may advantageously be used for driving the route. An additional expansion is achieved by linking other vehicles, which jointly cooperate in a crowd (what is known as “crowd sourcing”). A collective view of traffic situations is thereby generated or aggregated in the process.

Hereinafter, “aggregating” and “aggregation” denote compiling, combining and evaluating various items of information and contents and their storage in one or a plurality of suitable location(s). Suitable locations may be developed as digital maps, for example, which are located inside and/or outside the vehicle on a server device. In the case of an external server device, a communications device will be required in the vehicle with the aid of which the vehicle is able to communicate with the external server device and to transmit data to/from the external server device.

The information may relate to the following, for example:
local information
temporal information
behaviors (best practices of road users)
external marginal conditions
other information.

The local information, for example, may relate to the following:
Position information, which is stored by GPS coordinates, for instance, or is developed in the form of relative coordinates within the respective situation,
Static position information (a slowly changing infrastructure such as traffic lights, traffic signs etc.)
Positions of vehicles.

Temporal functions may pertain to the following, for example:
Points in time
weekdays/months
day/night information

Behavior patterns or best practices, for instance, may relate to the following:
a vehicle in a lane drives across an intersection
a pedestrian crosses the street.

External marginal conditions may relate to the following, for example:
the weather
the road condition
daylight

The other information, for instance, may describe the following:
accident hotspots (e.g., from police statistics)
construction sites (e.g., in the form of data from traffic control authorities)

In the mentioned collection, all enumerated information of a vehicle or a plurality of vehicles is detected by vehicle sensors (such as cameras and/or vehicle dynamics sensors) and/or radar sensors and/or navigation devices and/or further sensors, and transmitted to a combination device.

In the mentioned combination with the aid of the combination device, all items of information are compared to one another in order to arrive at the most uniform and correct image of the situation possible. The combined information is stored in a digital map based on its location information. An evaluation is carried out for this purpose in order to arrive at the correct information.

The example steps are able to be used in very many situations, a few of which are described in the following text, and they may be employed in many driver-assistance and automatic driving-function systems.

In an advantageous manner, this may be used especially for vehicles that are driving in an automated or automatic manner or for autonomously driving vehicles, which, in addition to their sensor-based environment detection, are able to utilize additional information in the form of aggregated data pertaining to best practices of other road users. Shortcomings in the area of reliability and availability of the situation awareness of traffic scenarios may be remedied in this manner.

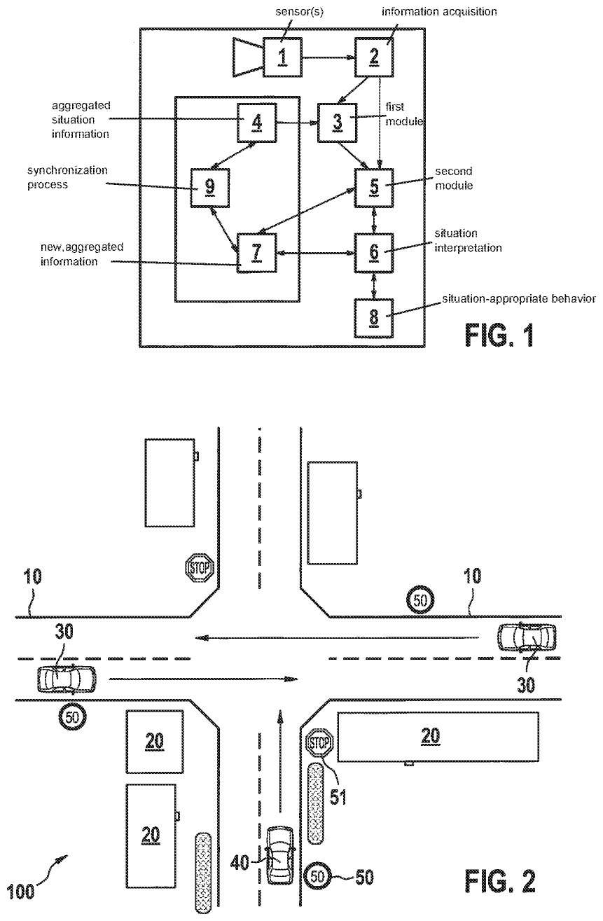

FIG. 1 shows a basic system structure of provided method 100. Sensors 1 (e.g., camera, radar, lidar ultrasound, etc.) of the vehicle detect a vehicle environment, in the course of which an information acquisition 2 is carried out. The current information may optionally be combined with aggregated situation information 4 in a first module 3. Aggregated situation information include both:
a) local information (this is known from digital maps)
b) temporal information, making it possible to link local with temporal information, for instance, and
c) the behavior of road users in the context of an infrastructure.

The temporal and/or local aggregation is achieved with the aid of a second module 5.

The result of this aggregation is able to be stored in new, aggregated information 7. The information is synchronized with the aid of a synchronization process 9, based on which another aggregating situation detection 4 is able to be carried out. Aggregating situation detection 4, aggregated information 7, and synchronization process 9 may be processed or executed inside the vehicle and/or outside a vehicle, in what is referred to as the backend, for instance.

The results of second module 5 and, optionally, aggregated information 7 are combined into a situation interpretation 6 in the vehicle. It is used to derive a suitable, situation-appropriate behavior 8 for the vehicle.

Ultimately, an examination of the behavior of road users in the context of the infrastructure, external influences in the presence of temporal and/or local dependencies is carried out.

The method for a situation interpretation of the driving situation or the traffic scenario uses at least one sensor device for detecting an environment, e.g., a video camera and/or radar sensors and/or digital maps and/or locating information (e.g., GPS data) and/or further environment sensors and aggregated information from the mentioned sensor devices, for a description of the situation.

The objective is an improvement in the location- and/or time-specific driving behavior for automated and/or automatic and/or manual driving. The following aspects are being taken into account:
How did a vehicle whose behavior was detected behave in the current situation?
Is there a best practice under the current marginal conditions?
What is to be expected as a function of the current location and the current time?
Is it likely that the current situation will deviate from the expected aggregated situation? (Example: the road is currently icy and the road users in the traffic scenario drive very slowly. There is currently a lack of data in the aggregated information regarding a traffic scenario that was stored under icy conditions).
Is there an unexpected behavior of road users? (Example: a vehicle driving ahead deviates from the normal course, which is a sign of an abnormality. Using the provided method, certain functions such as the emergency braking system may therefore be put into a raised state of operativeness)
Is it possible to utilize best practices of vehicles driving ahead?
Is it possible to draw conclusions about the current situation based on the behavior, the movement and/or the intentions of the road users?

The provided method may make it easier to find answers to the above questions, thereby assisting in improving the interpretation of the situation of a traffic scenario, which may advantageously contribute to greater driving safety in that the situation interpretation of the traffic scenario is utilized in a specific manner (e.g., for a driver-information system, a driver-assistance system, a control system, etc. of the vehicle).

Below, examples of location-dependent traffic scenarios that are able to be detected and processed by the method according to the present invention are enumerated by way of example:

Driving situations differ considerably with regard to the respective road forms; on interstates, for instance, an evenly flowing traffic in the higher speed range is realized. Exceptions are the following events, which are able to be managed by the provided aggregating method, for example. The following lists are not to be considered complete but simply mention a few application cases by way of example:
aggregation of congestion hotspots (including the times)
on-ramps and off-ramps
accident hotspots
building corridors for emergency vehicle access
long-term construction sites
slowly moving vehicles (e.g., trucks in uphill areas)
merging of slow vehicles (e.g., end of a slow-moving traffic lane)
weather effects (e.g., frequency of fog in certain route sections)
restricted visual conditions (e.g., possible light from oncoming vehicles/blinding in certain route sections at certain times)
possibility of aquaplaning
poor road surface, reduced tire grip (reduced coefficient of friction).

In addition to the long-term topics that are based more on the infrastructure, there is also the following current information that might be relevant:
current traffic controls
current speed limits
current additional bans (e.g., ban on passing)
current construction sites (day construction sites, also shifting sites)

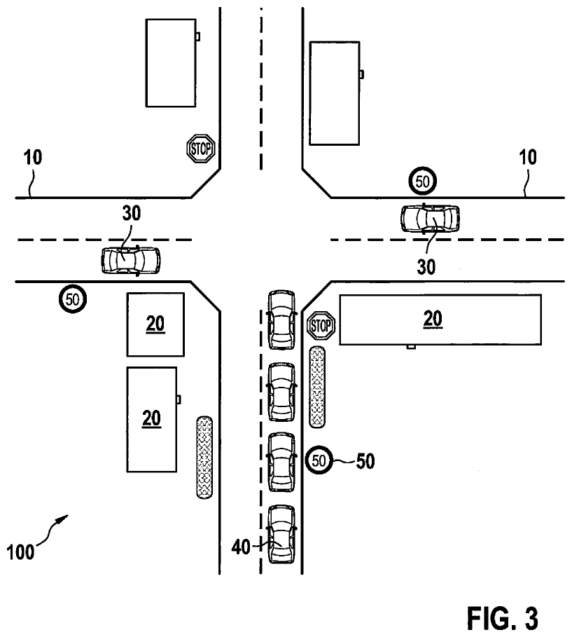

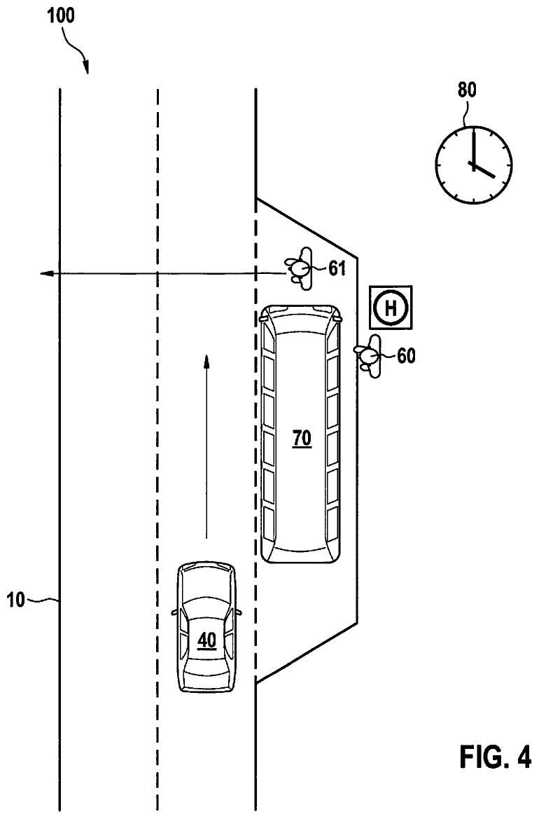

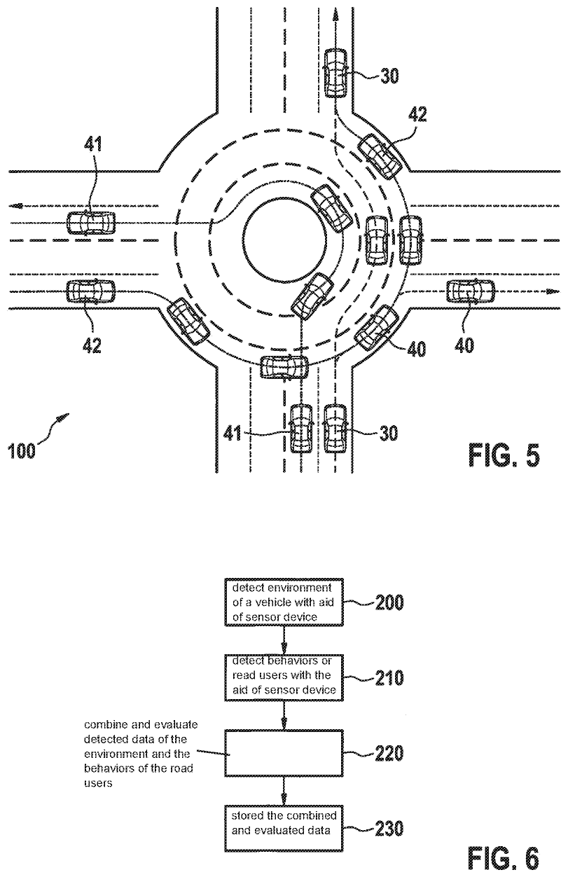

In addition to the interstate situations, the following additional situations and events that are able to be detected and processed by the aggregating method are encountered on highways:
intersections of any type (e.g., intersection featuring a plurality of roads branching off (right of way not always obvious, overlaps by infrastructure, turn-off lanes, widening lanes, intersections with three roads branching off)
an intersection with three roads branching off (T-intersection), where there is the risk that the driver will not recognize a stop in a timely manner or where there is a confusion risk with a road that has priority
merging lanes
driveways and exits (e.g., driveways leading to agricultural holdings, dirt roads, industrial operations, dirty roadways at construction sites)
intersecting sports paths
steep curves (e.g., winding roads on mountain passes)
motorcycle routes
routes on which vehicles often cut corners
scenarios in which an evasive behavior must be adapted because large vehicles are unable to make way for others
steep uphill gradients/downhill gradients (risk that the vehicle makes contact with the ground)
developing congestion with a resulting accident risk such as described in the traffic scenario in FIG. 3, for instance.

On inner-city streets, the following further situations arise in addition to interstate and highway situations:
Local roads with objects such as schools, playgrounds, athletic fields, hotels, bus stops, such as described in the traffic scenario in FIG. 4
residential streets featuring tempo 30 zones, car-restricted roads, children at play, persons with baby carriages, walker, wheelchair etc.
bottlenecks with narrow streets, parked vehicles/delivery vehicles
intersections with frequently confusing traffic routing, where a position of traffic lanes is unclear, complex intersections
traffic circle with considerably differing driving behaviors of different road users, complex traffic routing with numerous possible decisions as described with the aid of traffic scenario 100 of FIG. 5
elevated roads featuring traffic routing on multiple levels
emergency services providing medical care, police, fire truck entrances, hospital driveways, police stations, right of way of emergency vehicles
social institutions such as senior citizen homes, children's homes, homes for the blind, homes for the blind and deaf.

Regardless of the locality, traffic events that may have to be expected at the respective locality frequently occur, such as:
congestion
slow-moving traffic, stop and go traffic
accident hotspot.

The local situations are described by the respective infrastructure and the road users that are involved. For example, elements of the infrastructure may include the following:
Road elements in the form of traffic lanes having markings and side boundaries or other boundaries of the drivable area, such as traffic lane markings, stop lines, keep-out areas, curbstones, gutter channels, (warning) beacons, bus lanes, pedestrian crosswalks, pedestrian paths, arrows (e.g., to denote the driving direction in the traffic lane), traffic signs on the roadway, pictograms or other symbols on the roadway, general lettering on the roadway, grass cover
parking areas, parking strips
side paths/approach roads, e.g. junctions with the road (side streets, driveways and exits), pedestrian/bicycle lanes
traffic islands
guide posts or other lateral boundary signs (e.g., mile posts)
guardrails
road illumination devices
transitions to other traffic means, such as ferries, auto trains, airports, etc.
signaling elements such as traffic signs (static and/or variable traffic signs), traffic flow rules, speed rules, traffic lights (light-signal systems), warning lights (e.g., yellow blinking light), sound barriers.

The road users move within the infrastructure listed above by way of example. A description of the road users may include the following features, although expansions are also possible:

The road users as a whole have an interrelationship with the infrastructure:
Traffic flow, e.g., moving, normal, slow-moving, stop and go, congestion.

The current traffic flow may be allocated to individual infrastructures, such as:
Traffic-flow effects by intersections, traffic light systems, etc.
allocation of a traffic flow to individual traffic lanes (e.g., congestion in the right-turn lanes at certain intersections)
congestion at an intersection because the low-priority traffic (“stop”/“grant right of way”) is unable to move on due to the high traffic density on the priority road, as illustrated with the aid of the traffic scenario in FIG. 3
overloading of merging and exit lanes.

The road users have the following characteristics:
Type of road user: persons (pedestrians, children, handicapped persons (e.g., disabled, blind, etc.)
animals such as farm animals (cows, horses, etc.), wild animals (deer, wild boars, etc.)
vehicles such as passenger cars, trucks, motorcycles, scooters, bicycles, buses (in moving traffic and at bus stops)
rail vehicles (e.g., S-train, subway, long-distance train, light rail vehicle, etc.)
emergency vehicles (e.g., fire trucks, ambulances, etc.)
agricultural vehicles, e.g., tractors/tractor trucks, possibly with trailer, combine harvesters, straw-cutting machinery, clearing machinery, etc.
special vehicles such as snow plows, snow blowers, mowing machines.
Type of movement of the user, such as a uniform movement (constant speed), accelerated movement (movement featuring a change in speed), stopping, starting to drive, standing in traffic, standing in a parking area, parking in the second row (e.g., delivery vehicles), involved in an accident.
Direction: e.g., unchanging direction, changing direction
If the vehicle is moving smoothly, then this is an indication of a smooth road/surface
If the vehicle exhibits strong cyclical rolling and tilting motions, then this is an indication of an uneven road/surface
Location of the road user, e.g., defined by a geo-coordinate (e.g., GPS coordinate, etc.), relative distances to road users and/or to roadway boundaries.

Using the aforementioned observations, the current behavior (also known as action recognition) of the road users and—through a change in behavior—an intention of the user (also known as intention recognition) are able to be identified. There are observable indicators that announce said intentions, such as:
Activating the blinker (turn-signal indicator)
brake lights
blue lights/yellow lights
gaze direction (of pedestrians and vehicle drivers)

Monitoring the presence, the behavior and the intentions of the road users allows for indirect inferences in connection with the infrastructure, in the following manner:
In places where vehicles are driving, there is usually a drivable surface (e.g., a road)
the location that vehicles are approaching (usually masked by the vehicle itself and thus not directly detectable by sensors) may suggest with a high degree of probability a drivable surface (e.g., road), depending on the speed and the orientation of the vehicle (extended longitudinal prediction)
vehicles usually drive at a certain distance from the side boundaries of the drivable surface
when driving through complex intersections, vehicles select certain driving corridors or drive along other usual driving paths (even without markings on the roadway)
vehicles stop in front of certain infrastructure devices: for instance in front of traffic lights, stop signs, etc.
vehicles change lanes in front of certain infrastructure devices, e.g., turn-off lanes
vehicles line up when roadways narrow (alternate merge method)
they grant the right of way at certain intersections
vehicles wait ahead of certain situations (e.g., bottlenecks, congestion, driveways, buses, light rail vehicles, etc.)
cautious driving of vehicles when deer crossings are likely at a certain time of day
cautious driving at bus stops where people are just entering or exiting a bus, as described in connection with the traffic scenario in FIG. 4
numerous additional examples result from a combination and the context of the infrastructure and road users.

The following time-related information may be examined when detecting and processing the respective traffic scenario:
the date
the time of day: chronological time, day/night, information pertaining to temporal effects (e.g., rush hour), general statistics regarding traffic frequency as a function of the time of day
the time of the week: e.g., weekend status, beginning/end of the week (such as increased holiday travel on the weekend)
the season: spring/summer/fall/winter, holidays (school holidays, business holidays, semester breaks at universities, etc.).

The following external influences may be examined for the detected and processed traffic scenario:
Visibility such as the light intensity, darkness, oncoming light
weather conditions such as dryness (in general and dryness of the road), moisture, snow, ice
temperature: e.g., of the air, the road, great heat (resulting in a hectic driving behavior), cold (resulting in a concentrated driving behavior).

The detection of the respective information in connection with the situation, the infrastructure and the behavior of road users and the own behavior is carried out using suitable environment sensors, it being possible to use the following sensor devices:
Light sensor
temperature sensor
driving-dynamics sensors, e.g., for detecting the speed and the acceleration of the ego vehicle, possibly also the coefficient of friction of the road
locating sensors (for ascertaining the geo-position)
digital maps
vehicle-environment detection sensor, such as video cameras, radar sensors, lidar sensors, ultrasonic sensors, further sensors
communication with other road users, e.g., via C2C communication
communication with the traffic infrastructure, e.g., via C2X communication
access to further data such as aggregated information
microphone (such as for the detection of an emergency siren, horn, etc.).

The mentioned aggregation uses external information (for instance accident statistics and police data) and carries out an aggregation on the basis of observations by other road users (crowd sourcing), police and highway traffic authorities.

All of the following or a selection of the following is/are aggregated:
Characteristics and/or behaviors of road users
information with regard to the traffic infrastructure
information with regard to external influences such as the weather and light influences
local information (absolute or relative positions of the respective situation elements)
time information (when did the passage through the respective traffic scenario occur).

The mentioned aggregation, i.e. the detecting of the behaviors of the road users with the aid of the sensor device, and the combining and evaluating of the acquired data of the environment, may be carried out in the ego vehicle and/or in on an external system and be correspondingly stored internally and/or externally in a memory or a plurality of memories. All of this may be employed to enable the ego vehicle to know a great number of imponderables of a route and specifically utilize them, as a result of a situation-specific aggregation of behavior patterns. In an advantageous manner, the safety during a driving operation may be considerably increased in this manner.

FIG. 2 shows an exemplary traffic scenario 100 in which the provided method is able to be employed. An intersection situation is shown which features a priority road 10 and a danger potential as a result of crossing traffic, which is masked by building 20 for a vehicle 40 that is approaching the intersection at a high speed. As a consequence, there is a risk that a traffic sign 50 (speed limit reduced to city speed) will be overlooked and a traffic sign 51 that controls the right of way (stop sign). Vehicles 30 driving on priority road 10 may be overlooked due to the overlap of building 20.

It is provided to sense and detect illustrated traffic scenario 100 using the provided method, the detected data being combined and evaluated so that the data ascertained in this manner are able to be used for specific purposes. For example, a driver-assistance system of a vehicle may thereby become aware of the danger potential when approaching the intersection situation of FIG. 2, and output a corresponding item of information or a warning message to the driver, such as in the form of an acoustic and/or optical warning message, an increased preparedness of a braking system, etc.

FIG. 3 shows a further traffic scenario 100, for which the provided method may be used. To be gathered is an intersection situation including a priority road 10 and a danger potential that arises from a developing congestion. A vehicle 40 approaches the congested area at a higher speed. Vehicles 30 traveling on priority road 10 prevent the vehicles stuck in the congestion from quickly leaving the area. Traffic sign 50 (speed limit to city speed) comes locally too late since the congestion area extends beyond the position of traffic sign 50. Buildings 20 additionally hamper the view of priority road 10.

In this case, as well, a detection with the aid of sensors, a combination and evaluation of the traffic scenario including the behavior of the road users is able to be carried out. The corresponding data are able to be shared with other road users so that future vehicles approaching traffic scenario 100 in Figure may advantageously profit from the ‘wealth of experience’ of vehicles that have already passed through the area.

FIG. 4 shows a further traffic scenario 100 for which the provided method is able to be utilized. In this case, traffic scenario 100 is developed as a bus stop at which a person 60 is entering a bus 70. At the same time, a further person 61 crosses road 10 behind bus 70 in order to switch to the opposite side of the road (indicated by an arrow). A vehicle 40 approaches this traffic scenario 100. There is the risk that its driver notices pedestrian 61 too late. Mentioned traffic scenario 100 takes place at a time 80 and it is likely that it may be repeated at the same time 80 on one of the following days.

In this case, as well, a detection of the traffic situation by sensors with the aid of the provided method is carried out, including a detection of the behavior patterns of road users, e.g., bus 70, pedestrian 60, 61, and this information is combined and evaluated in order to form aggregated data; the data may be used to ensure that future road users proceed with a greater level of alertness when approaching traffic scenario 100 of FIG. 4 at the given time 80. In an advantageous manner, it is thereby possible to prevent that persons 61 crossing roadway 10 behind bus 70 are overlooked.

FIG. 5 shows a further traffic scenario 100 for which the provided method is able to be used. In this case, traffic scenario 100 includes passing through a three-lane traffic circle. There are a number of behaviors of drivers:

A cooperative driving behavior of vehicles 30, 40, and 41: Vehicle 40 enters the traffic circle in the right/outer lane and leaves the traffic circle at the first exit, or in other words, carries out a right-turn maneuver. A further vehicle 30 enters the traffic circle in the center lane and leaves the traffic circle at the second exit, thus realizing straight-ahead driving. A further vehicle 41 enters the traffic circle in the left/inner lane and leaves the traffic circle at the third exit and thereby realizes a left-turn maneuver.

However, there is also an uncooperative driving mode of a further vehicle 42, which enters the traffic circle in the right/outer lane and permanently remains in the right/outer lane, leaving the traffic circle at the third exit. Vehicle 42 thereby realizes uncooperative turning because it crosses multiple intersections and crosses traffic lanes.

This example is meant to illustrate how many possible driving modes there may exist in certain driving situations and that all of them are part of a common practice in traffic situations. The best practices in the case of traffic scenario 100 of FIG. 5 are the initially mentioned three practices, but the practice mentioned last pertaining to vehicle 42 is also common. In an advantageous manner, all variants should be known because the vehicle driving in an automated or automatic manner is able to adjust to all variants and is able to take them into account accordingly.

The combining and evaluating of the acquired data may be accomplished in the form of averaging or in the form of defining exclusion criteria, but many other types of combining and evaluating of the acquired data are possible as well.

The provided method may advantageously be used for high-performance automatic and/or (partly) automated driving functions. The (partly) automated driving in the urban environment, on highways and on interstates is relevant in this context. However, the present method may advantageously also be used for manual driving, in which case optical and/or acoustic warning signals, for example, are output to the driver of the vehicle.

The present method advantageously makes it possible for vehicles to profit from data of other vehicles that were acquired with the aid of sensors. Ultimately, a reduced sensor expense is thereby necessary for vehicles because they profit from a sensor infrastructure of other vehicles.

In an advantageous manner, the method of the present invention may be used to provide high availability of a longitudinal and transverse control of vehicles, for example.

FIG. 6 shows a basic sequence of a specific embodiment of the provided method.

In a step 200, an environment of a vehicle 30, 40, 41, 42 is detected with the aid of a sensor device.

In a step 210, behaviors of road users are detected with the aid of the sensor device.

In a step 220, the detected data of the environment and the behaviors of the road users are combined and evaluated. In a step 230, the combined and evaluated data are stored.

It is of course understood that the sequence of steps 200 and 210 may be chosen as desired.

In an advantageous manner, the provided method is able to be realized with the aid of a software program using suitable program-code means, which runs on a device for ascertaining data of a traffic scenario. This allows for a simple adaptation of the present method.

One skilled in the art will modify the features of the present invention in a suitable manner and/or combine them with one another without departing from the core of the present invention.

1-11. (canceled)

12. A method for ascertaining data of a traffic scenario, the method comprising:
detecting an environment of a vehicle with the aid of a sensor device;
detecting the behaviors of road users with the aid of the sensor device;
combining and evaluating the detected data of the environment and the behaviors of the road users; and
storing the combined and evaluated data.

13. The method as recited in claim 12, wherein the combining and evaluating of the detected data of the environment and the behaviors of the road users are carried out inside or outside the vehicle.

14. The method as recited in claim 12, wherein the combined and evaluated data are stored in an internal or an external digital map of the vehicle.

15. The method as recited in claim 12, wherein the combining and evaluating of the acquired data includes averaging.

16. The method as recited in claim 12, wherein the combining and evaluating of the acquired data includes the use of exclusion criteria.

17. The method as recited in claim 12, wherein when combining and evaluating the detected data, at least one of the following is taken into account: a local aspect, a temporal aspect, aspects pertaining to behavior patterns, and the use of external information.

18. The method as recited in claim 17, wherein the external information includes at least one of the following: data pertaining to the weather, accident statistics and police data.

19. The method as recited in claim 12, wherein the combined and evaluated data are used for an information system and/or for a driver-assistance system of the vehicle.

20. A device for ascertaining data of a traffic scenario, comprising:
a sensor device configured to detect an environment of the vehicle, whereby behaviors of at least one road user are detected with the aid of the sensor device;
a processing unit configured to combine and evaluate the detected data of the environment and the behaviors of the at least one road user; and
a memory configured to store the combined and evaluated data.

21. The device as recited in claim 20, further comprising:
a communications device configured to transmit the detected and/or the combined and evaluated data.

22. A non-transitory computer readable data carrier on which is stored a computer program having program-code for carrying out the method for ascertaining data of a traffic scenario, the computer program, when executed by a computer, causing the computer to perform:
detecting an environment of a vehicle with the aid of a sensor device;
detecting the behaviors of road users with the aid of the sensor device;
combining and evaluating the detected data of the environment and the behaviors of the road users; and
storing the combined and evaluated data.
